(19) United States
(12) Patent Application Publication
(10) Pub. No.: US 2009/0223437 A1
(43) Pub. Date: Sep. 10, 2009

(54) GAUGE HAVING SYNTHETIC SAPPHIRE LENS

(76) Inventor: CLAUDIO R. BALLARD, HUNTINGTON, NY (US)

Correspondence Address: HOWISON & ARNOTT, L.L.P, P.O. BOX 741715, DALLAS, TX, 75374-1715, US

(21) Appl. No.: 12/397,450

(22) Filed: Mar. 4, 2009

Related U.S. Application Data
(60) Provisional application No. 61/034,664, filed on Mar. 7, 2008.

(51) Int. Cl. G01D 11/28

(52) U.S. Cl. 116/288

(57) ABSTRACT

An analog style gauge for a vehicle includes a face and a pointer that moves across the face to indicate a relative value of a parameter being measured, a bezel for mounting a lens over the face of the gauge and a lens formed entirely from a synthetic sapphire mounted in the bezel.

### CROSS-REFERENCE TO RELATED APPLICATIONS

This application claims the benefit of U.S. Provisional Application for Patent Ser. No. 61/034,664, filed Mar. 7, 2008, and entitled GAUGE HAVING SYNTHETIC SAPPHIRE LENS, the specification of which is incorporated herein in its entirety by reference.

### TECHNICAL FIELD

The following disclosure relates to an analog-type gauge having a synthetic sapphire lens.

### BACKGROUND

A typical automobile or truck has numerous gauges and indicators that inform the vehicle operator of the status of various parameters. Gauges used in automobiles and trucks may display the engine coolant temperature, the engine oil pressure, the revolutions per minute (RPM) of the engine, the speed of the vehicle and the amperage output of the vehicle alternator. Such conventional gauges typically have lenses formed from plastic or glass. However, such plastic or glass lenses are subject to being scratched by relatively common materials, e.g., dust, which often contains tiny particles of quartz or other abrasive materials.

Glass or plastic lenses are also susceptible to etching and discoloration by various chemicals such as cleaners, solvents and acids. The useable lifetime of the typically automobile has also increased over time. However, plastic lenses are susceptible to yellowing due to aging and exposure to various frequencies of radiation. Consequently, as a vehicle ages, the vehicle's gauge lenses may yellow, making the gauge difficult to read.

To improve the scratch-resistance of conventional glass and plastic lenses, it is known to apply very thin coatings of different materials such as artificial diamond-like coatings. However, these coatings may affect the optical properties of the lens, and do not significantly increase the overall strength of the lens because they are thin. Thus, there exists a need for a durable lens for automotive gauges that is strong, scratch-resistant and not susceptible to yellowing due to aging and exposure to radiation.

### SUMMARY

In one aspect thereof, an analog or digital type gauge adapted for adapted for mounting in an instrument console in a vehicle is configured to indicate a relative value of a parameter being measured to the vehicle operator. The gauge includes a bezel for mounting a lens over the face of the gauge and a lens formed entirely from a synthetic sapphire mounted in the bezel. In different embodiments, the gauge may be one of a tachometer, a speedometer, a coolant level indicator, a coolant temperature indicator, an oil pressure indicator, an oil level gauge, an amperage gauge or a tire pressure gauge.

In another aspect, an analog style gauge has a face, indicia, and a pointer that sweeps across the indicia to indicate a relative value of a parameter being measured is disclosed. The lens has a bezel for mounting a lens over the face of the gauge. The lens is formed from a synthetic sapphire mounted in the bezel. In one embodiment, the analog style gauge has an illuminated pointer and a light source for illuminating the pointer.

In one embodiment, an analog style gauge for a vehicle includes a face, indicia, and a pointer that moves across the indicia to indicate a relative value of a parameter being measured. The measured parameter may be one of the measured parameter is one of the vehicle's engine coolant temperature, the vehicle's engine oil pressure, the revolutions per minute (RPM) of the vehicle's engine, the speed of the vehicle and the amperage output of the vehicle's alternator. A bezel is provided for mounting a lens formed entirely from a synthetic sapphire over the face of the gauge. The synthetic sapphire lens has a hardness between about 8.5 and 9.5 on the Moh's scale.

In another aspect, a vehicle instrument consol includes a plurality of gauges adapted for mounting in the instrument console, each of the gauges configured to indicate a relative value of a parameter being measured. The gauges include a bezel for mounting a lens over the face of each of the gauges and a lens formed entirely from a synthetic sapphire mounted in each of the bezels. In different variations, the gauges may be one or move of a tachometer, a speedometer, a coolant level indicator, a coolant temperature indicator, an oil pressure indicator, an oil level gauge, an amperage gauge or a tire pressure gauge.

### BRIEF DESCRIPTION OF THE DRAWINGS

For a more complete understanding, reference is now made to the following description taken in conjunction with the accompanying Drawings in which:

FIG. 1 illustrates a front view of a gauge employing a synthetic sapphire lens;

FIG. 2 illustrates a cross-sectional view of a synthetic sapphire lens similar to the one shown in FIG. 1;

FIG. 3 illustrates is a front view of a digital type gauge employing a synthetic sapphire lens; and

FIG. 4 illustrates a plurality of the gauges of FIG. 3 mounted in the instrument consol of a vehicle.

### DETAILED DESCRIPTION

Referring now to the drawings, wherein like reference numbers are used herein to designate like elements throughout, the various views and embodiments of a gauge having synthetic sapphire lens. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

FIG. 1 is a front view of an analog type indicating gauge 10 including a synthetic sapphire lens 22 according to the present disclosure. In one embodiment, gauge 10 includes a bezel 12, a gauge face 14 and indicia 16 formed on face 14. Gauge 10 further includes a pointer 18 that is attached to a pivot 20 that extends outwardly from face 14. Pointer 18 and pivot 20 may be driven by an actuator (not shown) such as a micromotor or stepper motor positioned behind face 14 of gauge 10. In one embodiment, pointer 18 is formed from a light conductive material such that the pointer may be illuminated by a light source positioned below face 18 such as an LED. Different colored light sources may be used to illuminate the LED with different colors, for example, red, green and blue. Pointer 18 is configured to sweep across indicia 16 to indicate a relative value for the parameter being measured. In the illustrated embodiment, gauge 10 is a tachometer, hence pointer 18 indicates the RPM speed of the engine or motor to which gauge 10 is attached. In other embodiments, gauge 10 may provide a measurement of the engine coolant temperature, the engine oil pressure, the speed of the vehicle and the amperage output of the vehicle alternator.

Conventional analog style gauges typically have lenses formed from plastic or glass. Such plastic or glass lenses are subject to being scratched by relatively common materials, e.g., dust, which often contains tiny particles of quartz. Such glass or plastic lenses are also susceptible to etching and discoloration by various chemicals such as solvents and acids. Plastic lenses are also susceptible to yellowing due to aging and exposure to various frequencies of radiation. To improve the scratch-resistance of conventional glass and plastic lenses, it is known to apply very thin coatings of hard materials such as artificial diamond-like coatings. However, these coatings may affect the optical properties of the lens, and do not significantly increase the overall strength of the lens because they are so thin.

In accordance with the disclosure, lens 22 of gauge 10 is formed entirely from a transparent synthetic sapphire material. Synthetic sapphire comprises crystalline aluminum oxide having a hardness of approximately 9 on the Moh's scale. Synthetic sapphire is among the hardest known materials; it is much harder than quartz. Therefore, it is not scratched by ordinary dust; rather it may be scratched only with a diamond. Synthetic sapphires are also resistant to chemical attacks, radiation and aging. Synthetic sapphires are also approximately five times stronger than glass.

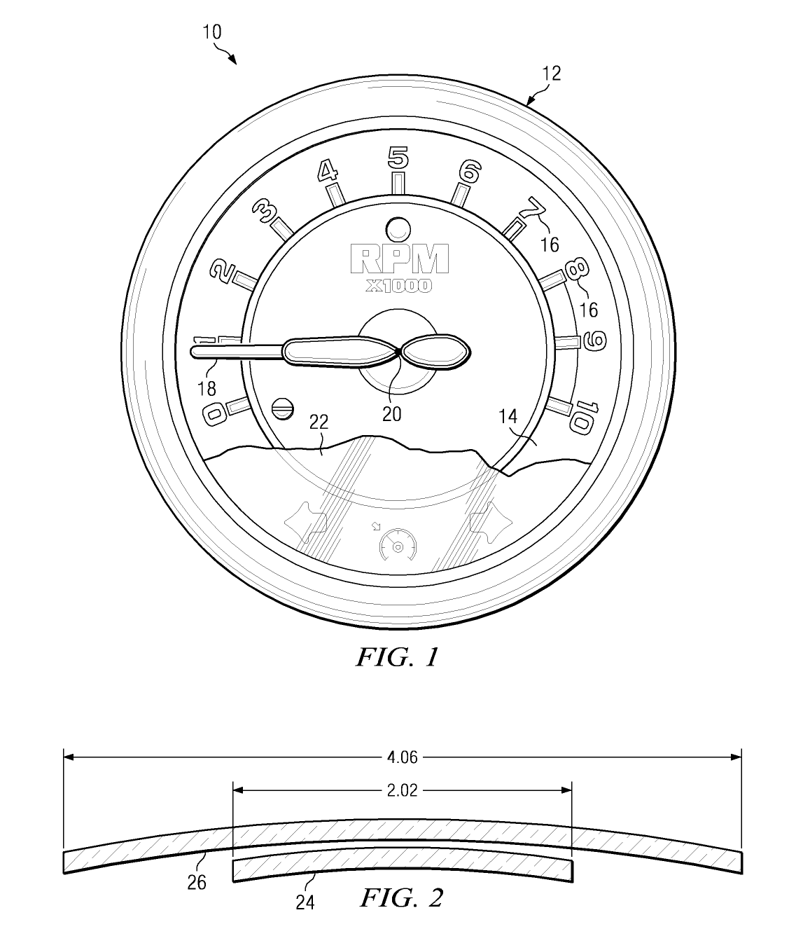

FIG. 2 is a cross section, to scale, across the diameters of first and second synthetic sapphire gauge lenses 24 and 26, respectively. In one embodiment, synthetic sapphire lens 24 has a diameter between about 1.95 inches and about 2.05 inches. In the illustrated embodiment, synthetic sapphire lens 24 has a diameter of 2.02 inches and is configured to be mounted in a bezel having an internal diameter of approximately 2.0 inches.

In other embodiments, a synthetic sapphire lens 26 has a diameter between about 3.95 inches and 4.10 inches. In the illustrated embodiment, lens 26 has a diameter of 4.06 inches. Lens 26 is configured to be mounted in an analog-style gauge with a bezel or mounting ring having an internal diameter of slightly over 4 inches. Lenses 24, 26 have a radius of curvature as illustrated in the scale drawing of FIG. 2. Lenses 24, 26 may have a thickness between 0.120 inches and 0.130 inches, preferably about 0.125 inches.

Analog and digital type gauges with synthetic sapphire lenses as disclosed herein have a number of advantages over gauges utilizing conventional glass or plastic lenses. Conventional glass or plastic lenses are subject to scratching and discoloration due to aging, exposure to chemicals and/or radiation. Alternatively the synthetic sapphire lenses may only be scratched by a substance having a hardness approaching that of a diamond and are not susceptible to discoloration due to aging or radiation and are relatively inert, hence less susceptible to etching or discoloration due to chemical attack.

Since transparent synthetic sapphire must be grown into single crystals, it is extremely expensive to produce crystals in sizes suitable for use in lenses having a diameter in the range of 2 inches to 4 inches. Further, because of its extreme hardness, the shaping and polishing of synthetic sapphire into such large curved lenses is a time consuming and expensive process that requires the use of diamond powder. Accordingly, the use of synthetic sapphire material for a gauge lens in accordance with this disclosure is not an obvious choice.

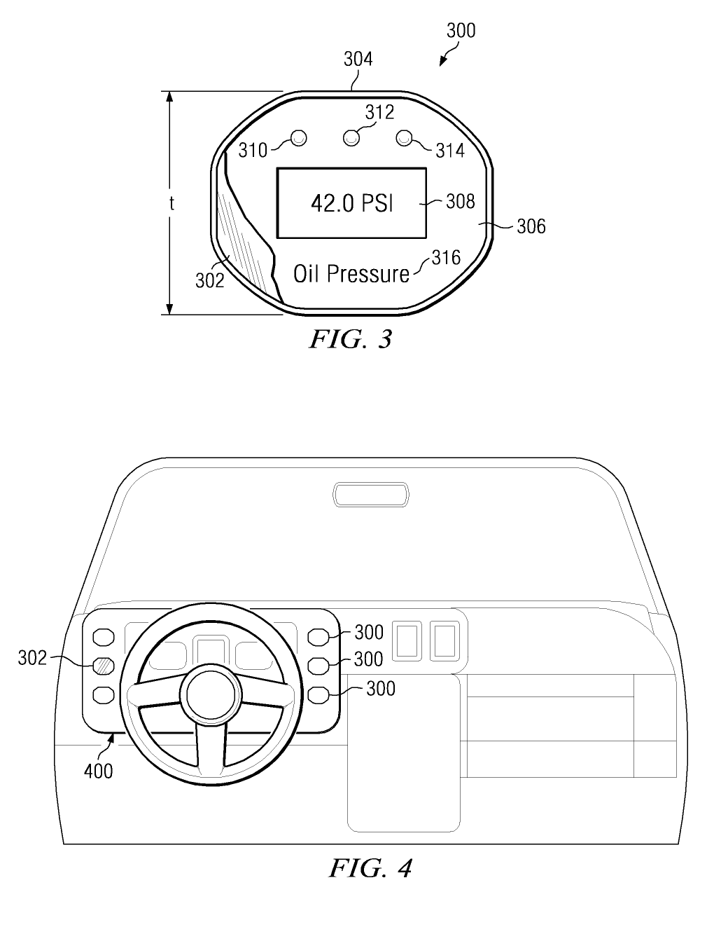

FIG. 3 is a front view of a digital type gauge 300 adapted for mounting in the instrument consol of a vehicle such as a car or truck. Gauge 300 includes a synthetic sapphire lens 302 having at least one transverse dimension t greater than 1.5 inches. In one embodiment, lens 302 is mounted in a bracket or bezel 304 so as to cover gauge face 306 and seal gauge 300 from dust and debris. Gauge face 306 may include indicia 316 that indicates the parameter being measured and displayed. Gauge 300 includes a digital display 308 such as a liquid crystal display for displaying the measured parameter. In the illustrated embodiment, gauge 300 displays the vehicle engine oil pressure; however in other embodiments gauge 300 may be configured as a tire pressure gauge, a tachometer, a speedometer, a coolant level or coolant temperature indicator, an oil level gauge or an amperage gauge for providing a measurement of the amperage output of the vehicle alternator.

In one variation, gauge 300 includes indicating lights 310, 312 and 314. Indicating lights 310, 312 and 314 may be colored LEDs, or white light sources with colored lenses for displaying a color indicative of the state of the measured parameter. For example, light 310 may be red when illuminated to indicate an oil pressure measurement below the desired range while light 314 may be blue when illuminated to indicate an oil pressure measurement above the desired range. Indicator light 312 may be green when illuminated to indicate an oil pressure measurement within the desired range.

FIG. 4 is a front view of a vehicle instrument panel 400 wherein a plurality of gauges 300 are mounted. Gauges 300 may include a tachometer, a speedometer, a coolant level indicator, a coolant temperature indicator, an oil pressure indicator or an amperage gauge. Each of gauges 300 includes a synthetic sapphire lens that covers the gauge and seals the gauge from dust and debris.

It will be appreciated by those skilled in the art having the benefit of this disclosure that vehicle gauges having synthetic sapphire lens provides a scratch-resistant, aesthetically pleasing analog-type or digital gauge. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A gauge adapted for mounting in an instrument console in a vehicle, the gauge configured to indicate a relative value of a parameter being measured;
a bezel for mounting a lens over the face of the gauge;
a lens formed entirely from a synthetic sapphire mounted in the bezel; and
wherein the gauge is one of a tachometer, a speedometer, a coolant level indicator, a coolant temperature indicator, an oil pressure indicator, an oil level gauge, an amperage gauge or a tire pressure gauge.

2. The gauge of claim 1 wherein the lens has a hardness between about 8.5 and 9.5 on the Moh's scale.

3. The gauge of claim 1 wherein the lens has a hardness of approximately 9 on the Moh's scale.

4. The gauge of claim 1 wherein the gauge has an illuminated pointer.

5. The gauge of claim 4 further comprising a light source beneath a face of the gauge for illuminating the pointer.

6. The gauge of claim 1 further comprising a dial face having indicia thereon and one of a micromotor or stepper motor for driving a pointer across the indicia.

7. An analog style gauge for a vehicle, the gauge having a face and a pointer that moves across the face to indicate a relative value of a parameter being measured;
a bezel for mounting a lens over the face of the gauge; and
a lens formed entirely from a synthetic sapphire mounted in the bezel.

8. The gauge of claim 7 wherein the measured parameter is one of the vehicle's engine coolant temperature, the vehicle's engine oil pressure, the revolutions per minute (RPM) of the vehicle's engine, the speed of the vehicle and the amperage output of the vehicle's alternator.

9. The gauge of claim 7 wherein the lens has a hardness between about 8.5 and 9.5 on the Moh's scale.

10. The gauge of claim 7 wherein the lens has a hardness of approximately 9 on the Moh's scale.

11. The gauge of claim 7 wherein the gauge has an illuminated pointer.

12. The gauge of claim 11 further comprising a light source beneath the face of the analog style gauge for illuminating the pointer.

13. The gauge of claim 11 further comprising one of a micromotor or stepper motor for driving the pointer across the indicia.

14. The gauge of claim 11 wherein the diameter of the lens is from about 2 inches to about 4 inches.

15. A vehicle instrument consol including a plurality of gauges adapted for mounting in the instrument console, each of the gauges configured to indicate a relative value of a parameter being measured;
a bezel for mounting a lens over the face of each of the gauges;
a lens formed entirely from a synthetic sapphire mounted in each of the bezels; and
wherein each of the gauges is one or more of a tachometer, a speedometer, a coolant level indicator, a coolant temperature indicator, an oil pressure indicator, an oil level gauge, an amperage gauge or a tire pressure gauge.

16. The vehicle instrument consol of claim 15 wherein the lenses have a hardness between about 8.5 and 9.5 on the Moh's scale.

17. The vehicle instrument consol of claim 15 wherein the lenses have a hardness of approximately 9 on the Moh's scale.

18. The vehicle instrument consol of claim 15 wherein one or more of the the gauges have an illuminated pointer and wherein the gauge further comprises a light source beneath a face of the gauge for illuminating the pointer.

19. The vehicle instrument consol of claim 18 wherein one or more of the gauges further comprise a dial face having indicia thereon and one of a micromotor or stepper motor for driving a pointer across the indicia.
